(19) United States
(12) Patent Application Publication
(10) Pub. No.: US 2018/0084921 A1
(43) Pub. Date: Mar. 29, 2018

(54) Projector Fixed on Electric Bed

(71) Applicant: APEX HEALTH CARE MFG, INC., Minxiong Township (TW)

(72) Inventor: Chi-Chung Huang, Minxiong Township (TW)

(21) Appl. No.: 15/279,484

(22) Filed: Sep. 29, 2016

(51) Int. Cl. A47C 21/00; G03B 21/14; G03B 21/64; A47C 20/04

(52) U.S. Cl. CPC A47C 21/003; A47C 20/041; G03B 21/64; G03B 21/145

(57) ABSTRACT

A projector is fixed on an electric bed and contains: a hollow body which includes a fixer, a projecting lamp, and a circuit board. The fixer is mounted on one end of the hollow body, and the projecting lamp and the circuit board are accommodated in the hollow body. The projector is fixed on one of two sides of the electric bed and is rotated relative to the electric bed, and the hollow body also includes an accommodation slot defined on one of two sides thereof and configured to house a clamper. A hollow cylinder is coupled with the projecting lamp and includes a recess formed on an intermediate section thereof and corresponding to the accommodation slot so as to accommodate the damper.

### FIELD OF THE INVENTION

The present invention relates to a projector which is fixed on an electric bed and projects patterns, number, or characters of a projection film.

### BACKGROUND OF THE INVENTION

A conventional electric bed contains an angle adjusting device mounted thereon so as to adjust using angle of the electric bed, and the electric bed contains at least one lamp fixed on a head end thereof so as to emit lights. However, the electric bed cannot project a variety of images of patterns, number, or characters.

The present invention has arisen to mitigate and/or obviate the afore-described disadvantages.

### SUMMARY OF THE INVENTION

The primary objective of the present invention is to provide a projector which is fixed on an electric bed and projects patterns, number, or characters of a projection film.

Another objective of the present invention is to provide a projector which is rotated toward a desired angle relative to the electric bed.

To obtain above-mentioned objects, a projector provided by the present invention is fixed on an electric bed and contains: a hollow body which includes a fixer, a projecting lamp, and a circuit board.

The fixer is mounted on one end of the hollow body, and the projecting lamp and the circuit board are accommodated in the hollow body.

The projector is fixed on one of two sides of the electric bed and is rotated relative to the electric bed, and the hollow body also includes an accommodation slot defined on one of the two sides thereof and configured to house a clamper.

In addition, a hollow cylinder is coupled with the projecting lamp and includes a recess formed on an intermediate section thereof and corresponding to the accommodation slot so as to accommodate the clamper.

### BRIEF DESCRIPTION OF THE DRAWINGS

FIG. 1 is a perspective view showing the assembly of a projector according to a preferred embodiment of the present invention.

FIG. 2 is a perspective view showing the exploded components of the projector according to the preferred embodiment of the present invention.

FIG. 3 is a side plane view of multiple projection films according to the preferred embodiment of the present invention.

FIG. 4 is a perspective view showing the assembly of two projectors and a control box according to the preferred embodiment of the present invention.

FIG. 5 is a perspective view showing the application of the projector according to the preferred embodiment of the present invention.

### DETAILED DESCRIPTION OF THE PREFERRED EMBODIMENTS

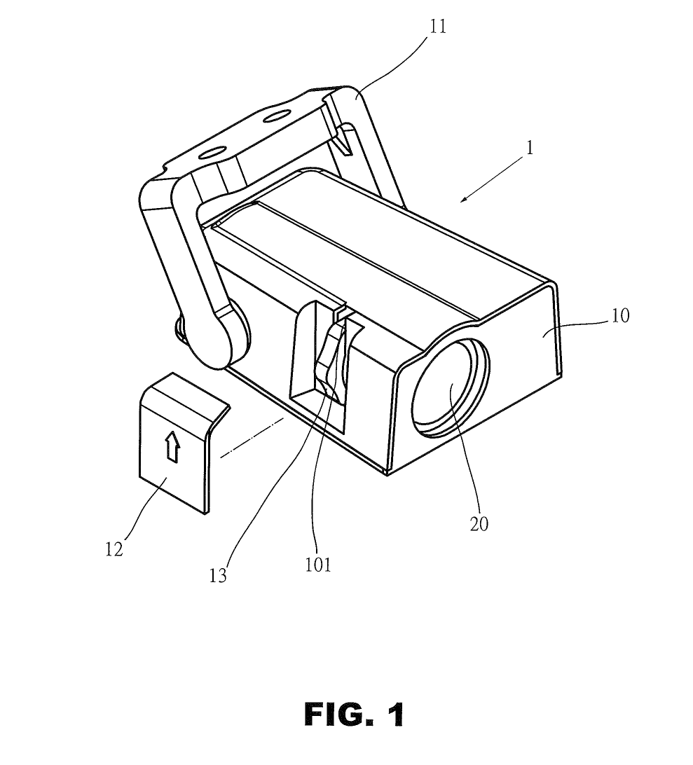

With reference to FIG. 1, a projector 1 according to a preferred embodiment of the present invention is fixed on an electric bed and comprises: a hollow body 10 which includes a fixer 11, a projecting lamp 2, and a circuit board 3, wherein the fixer 11 is mounted on one end of the hollow body 10, and the projecting lamp 2 and the circuit board 3 are accommodated in the hollow body 10. The hollow body 10 also includes an accommodation slot 101 defined on one of two sides thereof and configured to house a clamper 13, and the hollow body 10 further includes a protection cap 12 configured to cover the accommodation slot 101.

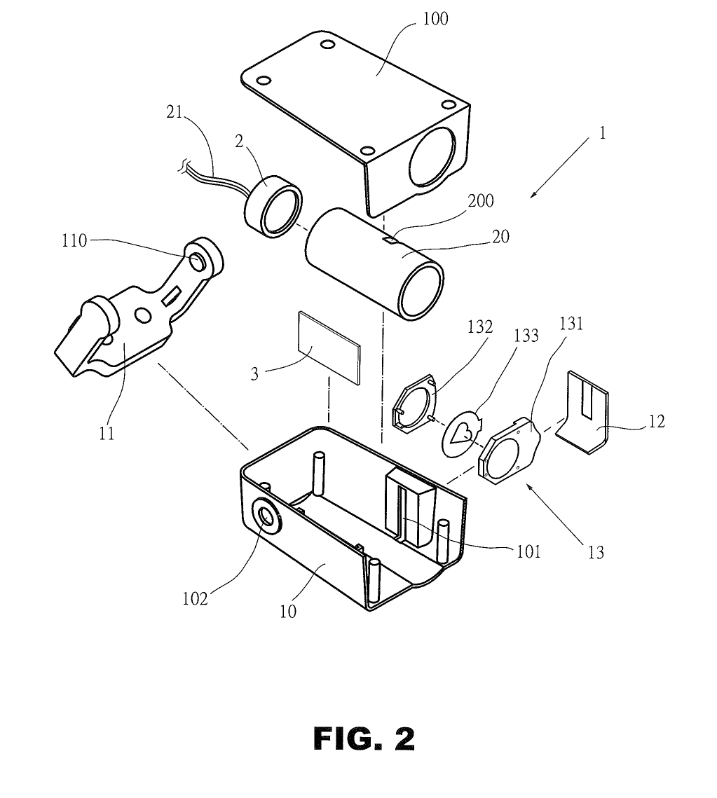

Referring further to FIG. 2, the hollow body 10 further includes a lid 100 connected with the hollow body 10 by way of multiple screws (not shown) or multiple locking elements (not shown), and the hollow body 10 include two dead orifices 102 defined on the two sides of the hollow body 10, respectively, such that the two dead orifices 102 of the hollow body 10 are rotatably connected with two connection columns 110 of the fixer 11, and the projector 1 is rotated toward a desired angle relative to the electric bed 3 by way of the two connection columns 110 and the two dead orifices 102.

The projecting lamp 2 is electrically connected with the circuit board 3 by way of a wire 21.

A hollow cylinder 20 is coupled with the projecting lamp 2 and extends out of the hollow body 10, and the hollow cylinder 20 includes a recess 200 formed on an intermediate section thereof so as to accommodate the clamper 13. The clamper 13 includes a first fixing sheet 131 and a second fixing sheet 132 between which a projection film 133 is fixed.

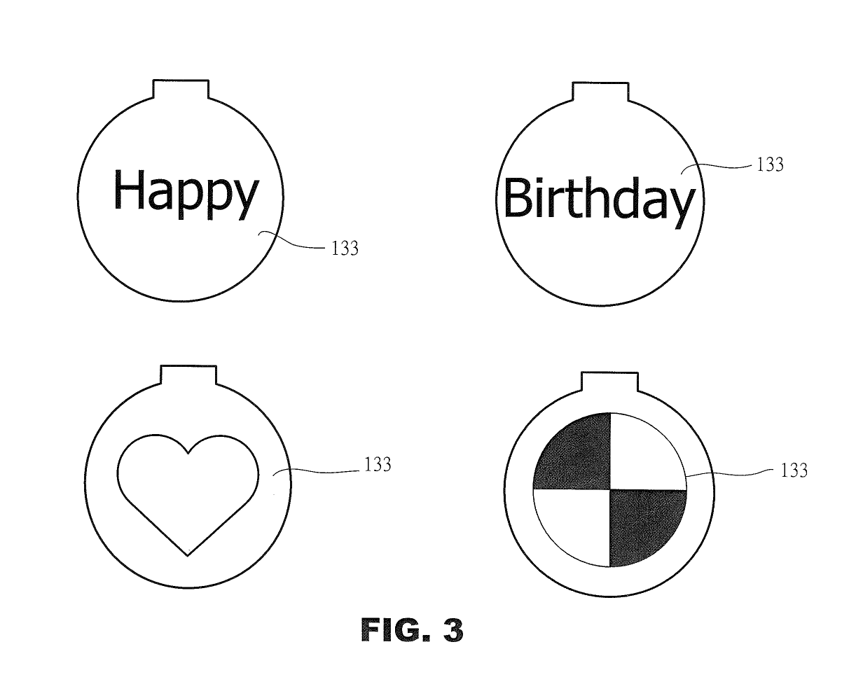

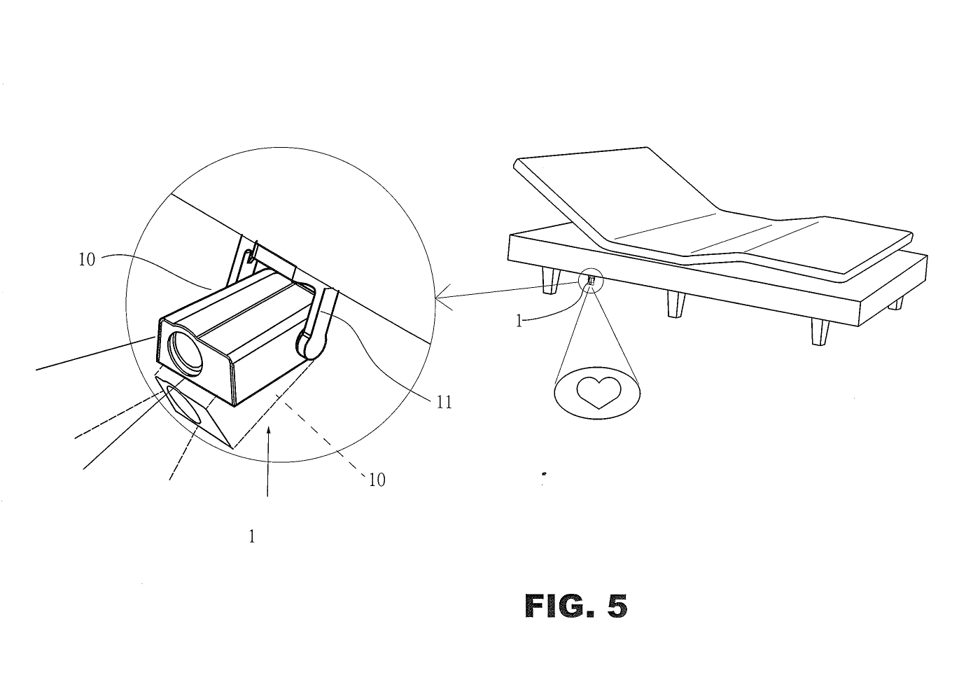

As shown in FIGS. 2 and 3, the projection film 133 is removed from the first fixing sheet 131 and the second fixing sheet 132 so as to replace another projection film based on using requirements. Preferably, the projection film 133 has patterns, numbers or characters formed thereon so as to project a variety of images of the patterns, the numbers or the characters. In addition, the projector 1 is rotated toward the desired angle relative to the electric bed 3, as shown in FIG. 5.

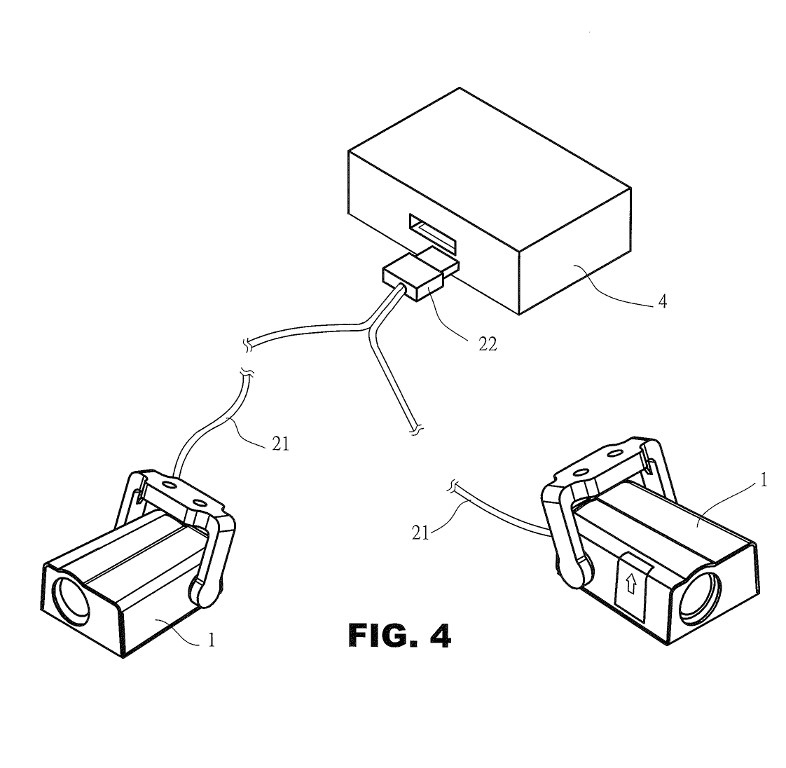

As illustrated in FIG. 4, two projectors 1 are electrically in connection with an electric connector 22 via two electrical cables 21, respectively, and the electric connector 22 is inserted into a control box 4 of the electric bed 3, such that the two projectors 1 are electrically conducted with the electric bed 3 and are controlled by the control box 4. Alternatively, one or at least three projectors 1 are electrically connected with the electric bed 3 based on the using requirements.

In application, as shown in FIG. 5, the projector 1 is fixed on one of two sides of the electric bed 3 by way of the fixer 11 which is screwed with the electric bed 3, and the hollow body 10 is rotated relative to the electric bed 3 by using the two dead orifices 102 and the two connection columns 110, thus projecting the images of the patterns, the number or the characters of the projection film 133.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

1. A projector being fixed on an electric bed and comprising: a hollow body which includes a fixer, a projecting lamp, and a circuit board;
the fixer being mounted on one end of the hollow body, and the projecting lamp and the circuit board being accommodated in the hollow body;
wherein the projector is fixed on one of two sides of the electric bed and is rotated relative to the electric bed;
wherein the hollow body also includes an accommodation slot defined on one of two sides thereof and configured to house a damper; and
wherein a hollow cylinder is coupled with the projecting lamp and includes a recess formed on an intermediate section thereof and corresponding to the accommodation slot so as to accommodate the damper;
wherein the damper includes a first fixing sheet and a second fixing sheet between which a projection film is fixed, and the hollow body further includes a protection cap configured to cover the accommodation slot.

2. (canceled)
